(19) United States
(12) Patent Application Publication
(10) Pub. No.: US 2014/0192928 A1
(43) Pub. Date: Jul. 10, 2014

(54) TRANSMISSION SYSTEM, SENDING DEVICE, RECEIVING DEVICE, AND TRANSMISSION METHOD

(71) Applicant: FUJITSU LIMITED, Kawasaki-shi (JP)

(72) Inventors: Yutaka SEKINO, Toyohashi (JP); Naoki Maezawa, Toyohashi (JP); YOSHIKI OKUMURA, KOSAI (JP); Chikahiro Deguchi, Toyohashi (JP)

(73) Assignee: FUJITSU LIMITED, Kawasaki-shi (JP)

(21) Appl. No.: 14/210,521

(22) Filed: Mar. 14, 2014

Related U.S. Application Data
(63) Continuation of application No. PCT/JP2011/071260, filed on Sep. 16, 2011.

(51) Int. Cl. H04L 7/10; H04L 7/00

(52) U.S. Cl. CPC H04L 7/10; H04L 7/0091
USPC 375/299; 375/356

(57) ABSTRACT

A transmission system includes a data sending device that sends data at a first speed and a data receiving device that receives, by using a plurality of clocks having different phases, data that has been sent by the sending device at the first speed. The data sending device sends, to the data receiving device, some of the data, which is sent at the first speed, at a second speed that is lower than the first speed. Furthermore, in accordance with determination as to whether the content of the received data sent at the second speed matches a corresponding portion of the data received by using a plurality of clocks, the data receiving device changes the timing at which the data that has been sent at the first speed is received.

### CROSS-REFERENCE TO RELATED APPLICATION(S)

This application is a continuation of International Application No. PCT/JP2011/071260, filed on Sep. 16, 2011, and designated the U.S., the entire contents of which are incorporated herein by reference.

### FIELD

The embodiments discussed herein are directed to a transmission system, a sending device, a receiving device, and a transmission method.

### BACKGROUND

There is a known transmission system that includes a data sending device that sends data signals and clock signals and a data receiving device that receives the data signals on the basis of the timing that is indicated by rising edges or falling edges of the clock signals.

In order to accurately receive the data signals, the data receiving device in the transmission system delays the phase of the received clock signal by a predetermined amount from the phase of the data signal. Then, the data receiving device receives a data signal by using, as a trigger, the rising edge or the falling edge of the clock signal whose phase is delayed.

The amount of delay in the data signal or the clock signal varies due to, for example, heat generated on a substrate. Consequently, when an error is detected from information that is indicated by a data signal received by the data receiving device or when the delay amount of the clock signal is initialized, the transmission system adjusts, by using a predetermined training pattern, the delay amount that is added to the clock signal of the data receiving device.

In the following, an example of a process in which a conventional transmission system adjusts, by using a training pattern, the delay amount that is added to a clock signal will be described with reference to the drawings. FIG. 13 is a schematic diagram illustrating an example of a conventional transmission system. In the example illustrated in FIG. 13, a data sending device 40 includes a send control unit 41, a clock sending unit 42, and a data sending unit 43. The data receiving device 44 includes a reception control unit 45, a data reception timing creating unit 46, a data reception flip flop (FF) unit 47, and an internal circuit 48.

With the transmission system having the above configuration, the send control unit 41 controls a data transmission process performed by the clock sending unit 42 and the data sending unit 43. The clock sending unit 42 sends a data queue strobe (DQS) signal as a clock signal. The data sending unit 43 sends a plurality of data queue (DQ) signals [0] to [n] as data signals. The reception control unit 45 controls a data receiving process performed by the data reception timing creating unit 46 and the data reception FF unit 47.

FIG. 14 is a schematic diagram illustrating an example of a process performed by a conventional data receiving device. In the example illustrated in FIG. 14, from among units included in the data reception FF unit 47, only the circuit that receives the DQ signal [0] is illustrated. In the example illustrated in FIG. 14, the data reception timing creating unit 46 includes a phase adjustment circuit (delay locked loop (DLL)) 46a and a delay 46b. Furthermore, the data reception FF unit 47 includes a delay 47a and a D-type flip flop 47b.

The data reception timing creating unit 46 delays the phase of a DQS signal by using the phase adjustment circuit 46a and the delay 46b. The D-type flip flop 47b latches the DQ signal [0] at the timing of the rising or the falling of the DQS signal that is delayed by the data reception timing creating unit 46 and then outputs the latched data to the internal circuit 48 as received data.

FIG. 15 is a schematic diagram illustrating an example of an error. FIG. 15 illustrated as an example indicates the phase of the DQS signal and four pieces of data that are sequentially sent by the DQ signals [0] to [3], respectively. Furthermore, in the example illustrated in FIG. 15, the phase of each of the DQ signal [0] and the DQ signal [2] is delayed from the phase of the DQS signal, the DQ signal [1], and the DQ signal [3]. Consequently, when the data receiving device 44 latches each of the DQ signals [0] to [3] at the first rising that is indicated by the DQS signal, the data receiving device 44 is not able to latch the data, which is sent for the first time, from the DQ [0] signal and the DQ [2] signal and thus an error occurs.

In such a case, because the data receiving device 44 adjusts the delay amount that is added to the DQS signal, the data sending device 40 sends the DQ signals [0] to [3] each of which indicates a training pattern. Furthermore, the data sending device 40 continues to send the DQ signals [0] to [3] that indicate the training pattern until the data receiving device 44 determines a delay amount. In contrast, by changing a delay amount that is to be added to the DQS signal by the phase adjustment circuit 46a, the data receiving device 44 sequentially receives the DQ signals [0] to [3] and then determines a delay amount by which a training pattern is reliably received.

If the data receiving device 44 detects the delay amount by which the training pattern can be reliably received, the data receiving device 44 sets the phase adjustment circuit 46a such that the detected delay amount is added to the DQS signal and then resumes the normal data receiving process. Furthermore, when the data receiving device 44 detects the delay amount by which the training pattern is accurately received, the data sending device 40 ends the sending process performed on the DQ signals [0] to [4] that indicate the training patterns. Furthermore, the data sending device 40 resumes sending the DQ signals [0] to [4], which indicate normal information, and the DQS signal. As to the information on related technologies, see Japanese Laid-open Patent Publication No. 2007-202033 and Japanese Laid-open Patent Publication No. 2001-154907, for example.

However, with the above described technology that adjusts the delay amount of a clock signal by using a training pattern, the training pattern is sent, without sending normal information, during the time period for which the delay amount of the clock signal by which the training pattern is accurately received is determined. Consequently, there is a problem in that the conventional transmission system decreases the efficiency of sending normal information.

### SUMMARY

According to an aspect of an embodiment, a transmission system includes a sending device and a receiving device. The sending device includes a first sending unit and a second sending unit. The first sending unit sends data at a first speed. The second sending unit sends, at a second speed that is lower than the first speed, some of the data sent from the first sending unit. The receiving device includes a clock creating unit, a plurality of receiving units, and a changing unit. The clock creating unit creates a plurality of clocks having different phases. The plurality of receiving units receive, by using the plurality of clocks created by the clock creating unit, respectively, the data that has been sent from the first sending unit. The changing unit changes, in accordance with determination as to whether the content of the received data sent from the second sending unit matches a corresponding portion of the data received by the plurality of receiving units, the timing at which the data that has been sent from the first sending unit is received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a transmission system according to a first embodiment;

FIG. 2 is a schematic diagram illustrating an example of a process performed by a thinning-out processing unit according to the first embodiment;

FIG. 3 is a schematic diagram illustrating data acquired by the thinning-out processing unit according to the first embodiment;

FIG. 4 is a schematic diagram illustrating an example of a data receiving device according to the first embodiment;

FIG. 5 is a schematic diagram illustrating an example of a data reception FF unit;

FIG. 6 is a schematic diagram illustrating the timing at which the data reception FF unit according to the first embodiment latches data;

FIG. 7 is a schematic diagram illustrating an example of a phase shift determining unit according to the first embodiment;

FIG. 8 is a schematic diagram illustrating an example of a phase shift determination circuit according to the first embodiment;

FIG. 9 is a schematic diagram illustrating an example of a process performed by a match position center extracting unit according to the first embodiment;

FIG. 10 is a schematic diagram illustrating the relationship among signals sent by a transmission system according to the first embodiment;

FIG. 11 is a flowchart illustrating the flow of a process performed by a data sending device according to the first embodiment;

FIG. 12 is a flowchart illustrating the flow of a process performed by a data receiving device according to the first embodiment;

FIG. 13 is a schematic diagram illustrating an example of a conventional transmission system;

FIG. 14 is a schematic diagram illustrating an example of a process performed by a conventional data receiving device; and

FIG. 15 is a schematic diagram illustrating an example of an error.

### DESCRIPTION OF EMBODIMENTS

Preferred embodiments of the present invention will be explained with reference to accompanying drawings.

### [a] First Embodiment

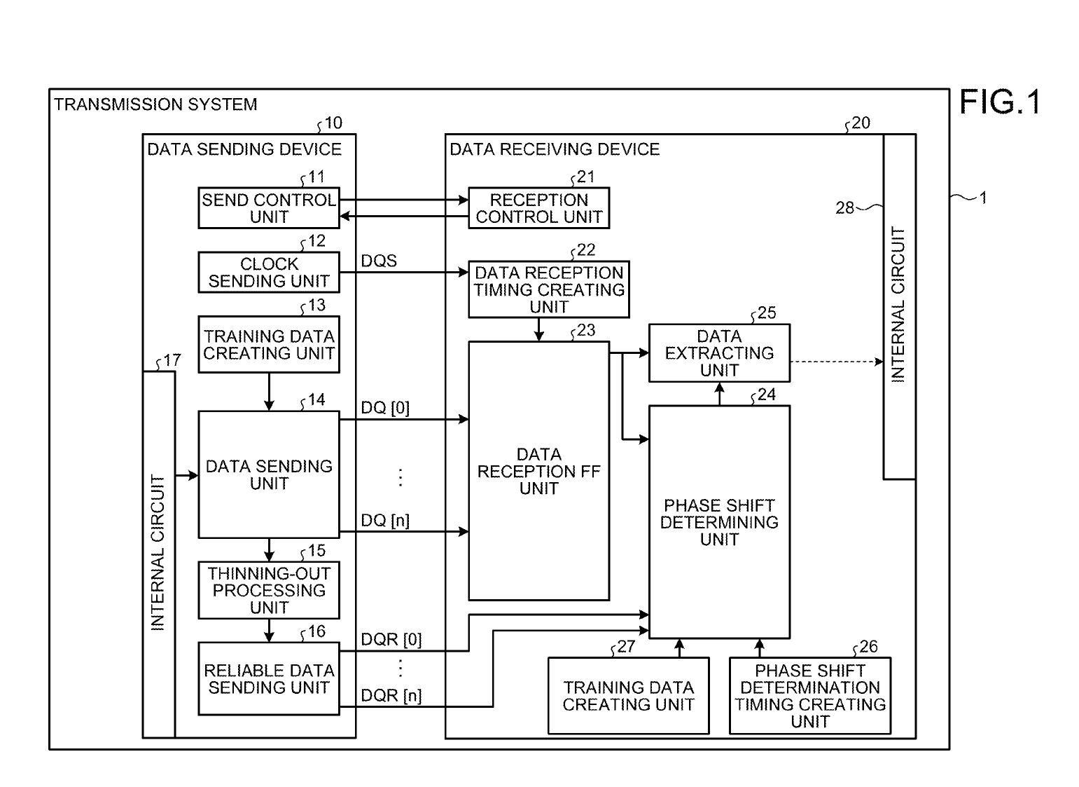

In a first embodiment described below, an example of a transmission system will be described with reference to FIG. 1. FIG. 1 is a schematic diagram illustrating an example of a transmission system according to a first embodiment.

In the example illustrated in FIG. 1, a transmission system 1 includes a data sending device 10 and a data receiving device 20. The data sending device 10 includes a send control unit 11, a clock sending unit 12, a training data creating unit 13, a data sending unit 14, a thinning-out processing unit 15, a reliable data sending unit 16, and an internal circuit 17. The data receiving device 20 includes a reception control unit 21, a data reception timing creating unit 22, a data reception flip flop (FF) unit 23, a phase shift determining unit 24, a data extracting unit 25, a phase shift determination timing creating unit 26, a training data creating unit 27, and an internal circuit 28.

The internal circuit 17 is the sending source of data sent and received between the data sending device 10 and the data receiving device 20. The internal circuit 28 is the sending destination of the data sent and received between the data sending device 10 and the data receiving device 20.

In the following, first, each of the units 11 to 17 included in the data sending device 10 will be described. The send control unit 11 is a control unit that controls a process for sending and receiving data between the data sending device 10 and the data receiving device 20.

For example, when the send control unit 11 receives, from the reception control unit 21 in the data receiving device 20, a send request for training data, the send control unit 11 sends a notification to the training data creating unit 13 indicating that training data is created. Then, the send control unit 11 controls the data sending unit 14 such that the training data created by the training data creating unit 13 is sent. Furthermore, if the internal circuit 17 sends data, the send control unit 11 controls the data sending unit 14 such that the data that is output by the internal circuit 17 is sent.

The clock sending unit 12 sends a clock signal to the data receiving device 20. For example, the clock sending unit 12 sends, as a clock signal to the data receiving device 20, a DQS signal that is a clock signal used when data is read and written to the double-data-rate synchronous dynamic random access memory (DDR SDRAM).

The training data creating unit 13 creates training data when the transmission system is booted up and then sends the created training data to the data sending unit 14. The training data mentioned here is a bit string that is defined in advance and that is used to adjust, between the data sending device 10 and the data receiving device 20, the phase of a clock signal and a data signal. For example, when the training data creating unit 13 receives a notification from the send control unit 11 indicating that training data is created, the training data creating unit 13 sends a predetermined bit string as the training data to the data sending unit 14.

The data sending unit 14 sends data signals to the data receiving device 20. For example, the data sending unit 14 sends, as a data signal to the data reception FF unit 23 in the data receiving device, a DQ signal that is a data signal used when data is written to a DDR SDRAM.

Specifically, the data sending unit 14 receives training data from the training data creating unit 13. In such a case, the data sending unit 14 creates DQ signals [0] to [n] that indicate bits included in the received training data. Then, the data sending unit 14 sends the DQ signals [0] to [n] indicating the training data to the data reception FF unit 23.

Furthermore, for example, when the data sending unit 14 receives data sent from the internal circuit 17, the data sending unit 14 divides the received data into n+1 bits of data and then creates the DQ signals [0] to [n] each of which indicates a bit of the divided pieces of data. Then, the data sending unit 14 performs burst transmission on the data that is obtained by dividing the DQ signals [0] to [n] each of which indicates a bit of divided pieces of data.

For example, when the data sending unit 14 receives data containing therein 4n+4 bits from the internal circuit 17, the data sending unit 14 divides the received data into four pieces of data, sequentially creates the DQ signals [0] to [n] that indicate the divided data, and then sequentially performs the burst transmission on each of the created DQ signals [0] to [n]. Specifically, the data sending unit 14 stores the data the amount of which corresponds to four cycles and then sequentially sends the stored data.

The thinning-out processing unit 15 acquires, from the data sent from the data sending unit 14, data at the cycle longer than that used by the data sending unit 14. Specifically, the thinning-out processing unit 15 acquires, from the DQ signals [0] to [n] sent from the data sending unit 14, data in every four times the data sending unit 14 sends the DQ signals [0] to [n]. For example, the thinning-out processing unit 15 acquires the third data that is to be sent from among four pieces of data retained by the data sending unit 14. Then, the thinning-out processing unit 15 sends the acquired data to the reliable data sending unit 16.

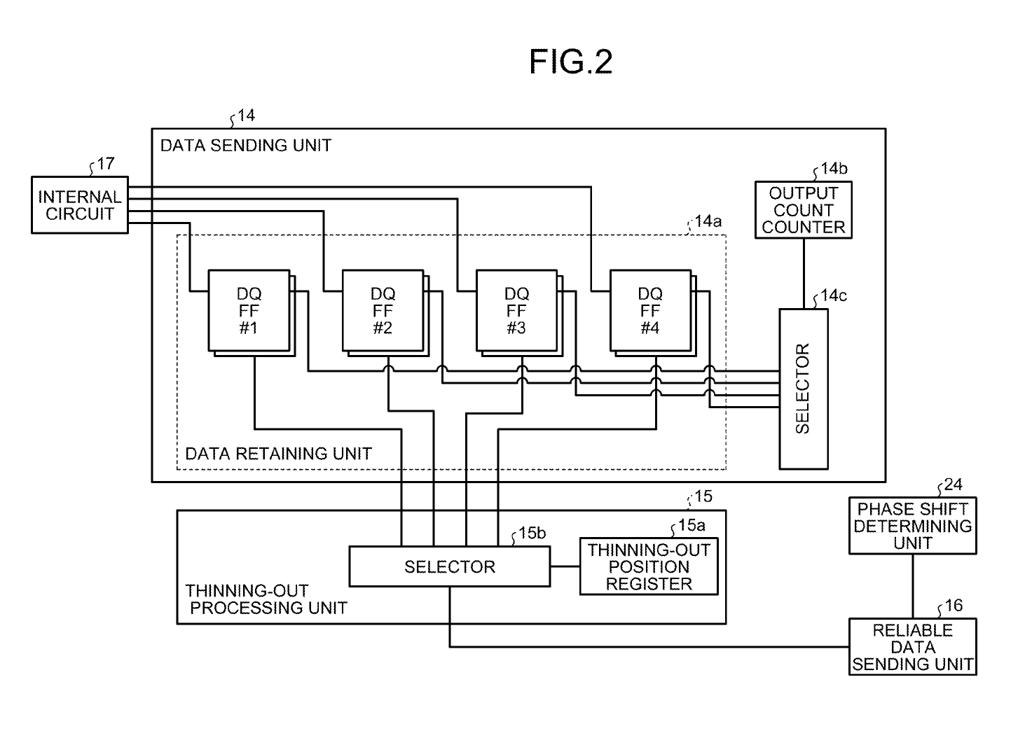

In the following, an example of a process performed by the thinning-out processing unit 15 will be described with reference to FIG. 2. FIG. 2 is a schematic diagram illustrating an example of a process performed by the thinning-out processing unit 15 according to the first embodiment. In the example illustrated in FIG. 2, it is assumed that the data sending unit 14 retains up to a maximum of four pieces of data that is subjected to the burst transmission. Specifically, it is assumed that the data sending unit 14 continuously performs burst transmission four times.

In the example illustrated in FIG. 2, the data sending unit 14 includes a data retaining unit 14a, an output count counter 14b, and a selector 14c. The data retaining unit 14a includes DQ FFs #1 to #4, which are D-type FFs that retain data received from the internal circuit 17. The thinning-out processing unit 15 includes a thinning-out position register 15a and a selector 15b. Furthermore, it is assumed that each of the DQ FFs #1 to #4 retains n+1 bits of data.

In the example illustrated in FIG. 2, the data retaining unit 14a sequentially stores the data received from the internal circuit 17 in the DQ FFs #1 to #4 such that n+1 bits of data is stored in each of the DQ FFs #1 to #4. The output count counter 14b is a counter that repeatedly counts the number from 1 to 4. The selector 14c increments the value of the output count counter 14b by 1 when data retained in one of the DQ FFs #1 to #4 is sent.

Then, the selector 14c refers to the value of the output count counter 14b and sends, as DQ signals [0] to [n], the data stored in the DQ FF that is indicated by the referred value. For example, when the selector 14c has sent the data stored in the DQ FF #2, the selector 14c increments the value “2” of the output count counter 14b by 1. Then, the selector 14c sends the data, which is stored in the DQ FF #3 indicated by the new value “3” of the output count counter 14b, as the subsequent DQ signals [0] to [n].

The thinning-out position register 15a retains a value indicating a DQ FF that retains data that is sent as the DQR signals [0] to [n]. The value stored in the thinning-out position register 15a is set by the send control unit 11. The selector 15b sends, to the reliable data sending unit 16, the value stored in the DQ FF indicated by the thinning-out position register 15a. For example, when the thinning-out position register 15a retains “3”, the selector 15b sends the value retained by the DQ FF #3 to the reliable data sending unit 16.

A description will be given here by referring back to FIG. 1. The reliable data sending unit 16 sends, to the phase shift determining unit 24 in the data receiving device 20 at a speed lower than that used for the DQ signals [0] to [n], the DQR signals [0] to [n] that indicate the data acquired by the thinning-out processing unit 15. Specifically, the reliable data sending unit 16 receives data acquired by the thinning-out processing unit 15. When the reliable data sending unit 16 receives the data acquired by the thinning-out processing unit 15, the reliable data sending unit 16 continuously sends, to the phase shift determining unit 24, the received data without processing anything until the thinning-out processing unit 15 receives new data.

Specifically, when a new value is stored in the DQ FF that is indicated by the thinning-out position register 15a, the reliable data sending unit 16 sends, to the phase shift determining unit 24, the new value of the DQ FF indicated by the thinning-out position register 15a.

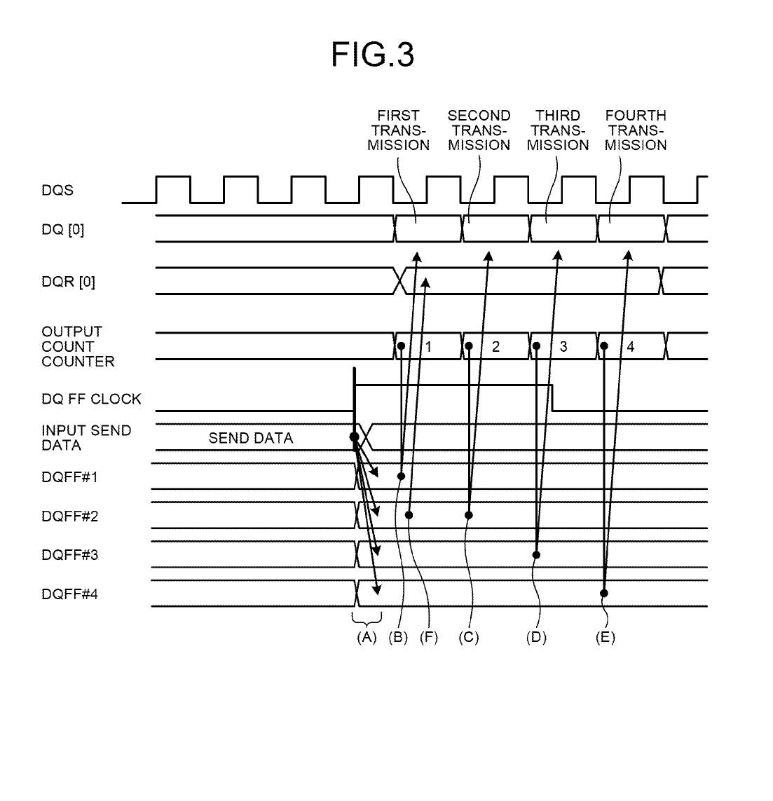

In the following, data acquired by the thinning-out processing unit 15 will be described with reference to FIG. 3. FIG. 3 is a schematic diagram illustrating data acquired by the thinning-out processing unit according to the first embodiment. FIG. 3 illustrates an example of the waveform of the DQS signal, the waveform of the DQ signal [0], the waveform of the DQR signal [0], the values stored in the output count counter, and the DQ FF clock that is an operation clock of each of the DQ FFs #1 to #4. Furthermore, FIG. 3 illustrates an example of the timing at which the send data acquired from the internal circuit 17 is input and the timing at which each of the DQ FFs #1 to #4 retains a value.

In the example illustrated in FIG. 3, first, the internal circuit 17 outputs data by an amount corresponding to that of the burst transmission is performed for four times. Then, as illustrated by (A) in FIG. 3, each of the DQ FFs #1 to #4 latches different data when, as a trigger, the rising edge of the DQ FF clock is obtained. Specifically, the DQ FF #1 latches the data that is subjected to the burst transmission for the first time and the DQ FF #2 latches the data that is subjected to the burst transmission for the second time. Furthermore, the DQ FF #3 latches the data that is subjected to the burst transmission for the third time and the DQ FF #4 latch the data that is subjected to the burst transmission for the fourth time.

In this example, as indicated by (B) in FIG. 3, when the value of the output count counter becomes “1”, the data latched by the DQ FF #1 is sent as the DQ signal [0]. Furthermore, as indicated by (C) in FIG. 3, when the value of the output count counter becomes “2”, the data latched by the DQ FF #2 is sent as the DQ signal [0]. Furthermore, as indicated by (D) in FIG. 3, when the value of the output count counter becomes “3”, the data latched by the DQ FF #3 is sent as the DQ signal [0]. Furthermore, as indicated by (E) in FIG. 3, when the value of the output count counter becomes “4”, the data latched by the DQ FF #4 is sent as the DQ signal [0].

At this point, when “2” is stored in the thinning-out position register 15a, the thinning-out processing unit 15 acquires the value that has been latched by the DQ FF #2 and then sends the acquired value to the reliable data sending unit 16. Consequently, as indicated by (F) in FIG. 3, the data that has been latched by the DQ FF #2, i.e., the data that has been sent as the DQ signal [0] for the second time, is sent as the DQR signal [0]. Furthermore, in the example illustrated in FIG. 3, because the thinning-out processing unit 15 acquires the data, which is sent in every four times the data sending unit 14 sends the DQ signals [0] to [n], the reliable data sending unit 16 sends the DQR signal [0] that has the cycle four times as long as the cycle of the DQ [0] signal.

A description will be given here by referring back to FIG. 1. The reception control unit 21 in the data receiving device 20 controls the receiving of data. For example, when the delay amount to be added to the DQS signal is adjusted by using training data, the reception control unit 21 sends a send request for the training data to the send control unit 11 in the data sending device 10. Furthermore, when the delay amount to be added to the DQS signal is adjusted, the reception control unit 21 allows the training data creating unit 27 to create training data and then performs the following process while changing the phase of the clock signal created by the data reception timing creating unit 22.

Namely, the reception control unit 21 allows the phase shift determining unit 24 to compare the training data with the data latched by the data reception FF unit 23. If the training data matches the data latched by the data reception FF unit 23, the reception control unit 21 allows the data reception timing creating unit 22 to retain the matched delay amount.

Furthermore, the reception control unit 21 communicates with the send control unit 11 and, as will be described later, the thinning-out processing unit 15 decides the thinning-out position that indicates whether the data, which is used as the DQR signals [0] to [n], corresponds to what number of the data that is sent by the data sending unit 14.

The data reception timing creating unit 22 receives a DQS signal from the clock sending unit 12 in the data sending device 10. Then, by using a delay locked loop (DLL) circuit or the like, the data reception timing creating unit 22 creates clock signals by delaying the phase of the DQS signal in stages. Then, the data reception timing creating unit 22 sends the created clock signals to the data reception FF unit 23.

The data reception FF unit 23 receives each of the DQ signals [0] to [n] sent by the data sending unit 14 in the data sending device 10 and receives the clock signals created by the data reception timing creating unit 22. Then, the data reception FF unit 23 receives each of the DQ signals [0] to [n] at different timings. Thereafter, the data reception FF unit 23 sends each of the received DQ signals [0] to [n] to the phase shift determining unit 24 and the data extracting unit 25. Specifically, the data reception FF unit 23 latches data from each of the DQ signals [0] to [n] at the timing indicated by the received clock signals and then sends the latched data to the phase shift determining unit 24 and the data extracting unit 25.

The phase shift determining unit 24 receives each of the DQ signals [0] to [n] received by the data reception FF unit. Furthermore, the phase shift determining unit 24 receives each of the DQRs [0] to [n] sent by the reliable data sending unit 16. Then, if the phase shift determination timing is notified by the phase shift determination timing creating unit 26, which will be described later, the phase shift determining unit 24 performs the following process.

Namely, the phase shift determining unit 24 detects, from the DQ signals [0] to [n] received by the data reception FF unit 23 at the different timings, a signal that does not match the DQR signal. For example, the phase shift determining unit 24 detects a DQ signal [0] that is different from the DQR signal [0] from among the DQ signals [0] received by the data reception FF unit 23 at the different timing. Specifically, the phase shift determining unit 24 detects, from the data that has been latched from the DQ signal [0] at the different timings, data that does not match the data that has been latched from the DQR signal [0]. Then, the phase shift determining unit 24 sends the detection result to the data extracting unit 25.

Furthermore, when the phase shift determining unit 24 receives an instruction to adjust a delay amount that is added to the DQS signal by using the training data by the reception control unit 21, the phase shift determining unit 24 performs the following process. Namely, the phase shift determining unit 24 determines whether the data created by the training data creating unit 27 matches the data received by the data reception FF unit 23 and then notifies the reception control unit 21 of the determination result.

When the phase shift determining unit 24 detects, from each piece of the data latched from the DQ signals [0] to [n] by the data reception FF unit 23 at the different timings, data that does not match the data that is read from the DQR signal, the data extracting unit 25 performs the following process. Namely, the data extracting unit 25 corrects the phase of the clock signal created by the data reception timing creating unit 22. Furthermore, the data extracting unit 25 sends, to the internal circuit 28, the data that is the same as the DQR signals [0] to [n] from among the data that has been latched from the DQ signals [0] to [n] by the data reception FF unit 23.

Specifically, the data extracting unit 25 performs the following process for each of the DQ signals [0] to [n]. Namely, the data extracting unit 25 selects, from the data that has been latched by the data reception FF unit 23, a predetermined number of data that has been read by clocks with continuous phases. Then, for the selected data, when the phase shift determining unit 24 detects data that does not match data that is read from the associated DQR signal, the data extracting unit 25 changes the selection of data such that the data in the direction in which the detected data is not included is selected.

Furthermore, when the phase shift determining unit 24 does not detect, from the selected data, data that does not match the data that is read from the DQR signal, the data extracting unit 25 sends, to the internal circuit 28, one of the selected data as received data.

The phase shift determination timing creating unit 26 notifies, at the same cycle as that of the DQR signals [0] to [n], the phase shift determining unit 24 of the phase shift determination timing. Specifically, the phase shift determination timing creating unit 26 notifies the phase shift determining unit 24 of the phase shift determination timing at the timing at which the data reception FF unit 23 receives the DQ signals [0] to [n] that indicate the same data as that indicated by the DQR signals [0] to [n], respectively.

The training data creating unit 27 creates the same training data as that created by the training data creating unit 13 in the data sending device 10. Specifically, when the reception control unit 21 instructs the training data creating unit 27 to create training data, the training data creating unit 27 creates the same training data as that created by the training data creating unit 13 and then sends the created data to the phase shift determining unit 24.

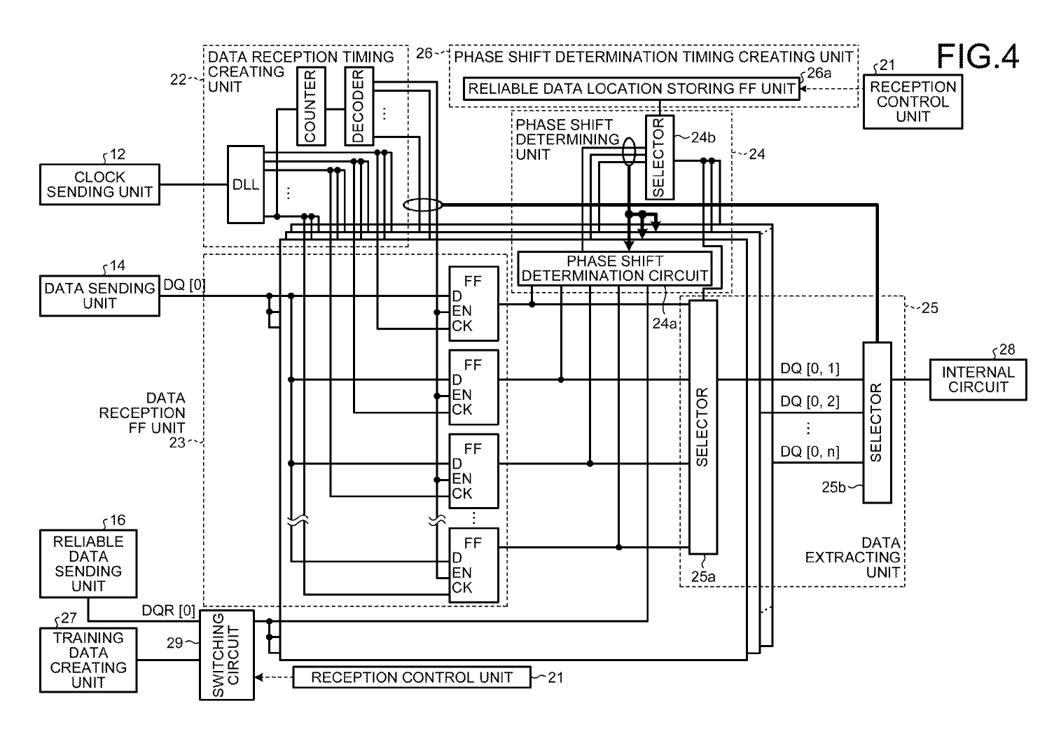

In the following, an example of the data receiving device 20 will be described with reference to a drawing. FIG. 4 is a schematic diagram illustrating an example of a data receiving device according to the first embodiment. In the example illustrated in FIG. 4, the data reception timing creating unit 22 includes a DLL circuit, a counter, and a decoder. The data reception FF unit 23 includes enable signal based D-type FFs. The phase shift determining unit 24 includes a phase shift determination circuit 24a and a selector 24b. The data extracting unit 25 includes a selector 25a and a selector 25b. The phase shift determination timing creating unit 26 includes a reliable data location storing FF unit 26a.

The data extracting unit 25 includes the selector 25a and the selector 25b. The phase shift determination timing creating unit 26 includes the reliable data location storing FF unit 26a. In the example illustrated in FIG. 4, it is assumed that units, each of which performs the same function as that performed by the FFs in the data reception FF unit 23, the phase shift determination circuit 24a in the phase shift determining unit 24, and the selector 25a in the data extracting unit 25, are installed for each DQ signal that is subjected to burst transmission. Specifically, it is assumed that the number of each of the FFs in the data reception FF unit 23, the phase shift determination circuit 24a, and the selector 25a is the same as the number of registers that are used to store therein data sent by the data sending unit 14.

The data reception timing creating unit 22 changes, by using the DLL circuit, the DQS signal sent by the clock sending unit 12 to clock signals having different phases in stages. Then, the data reception timing creating unit 22 inputs the created clock signal in each of the clock (CK) terminals, i.e., FFs, in the data reception FF unit 23. Specifically, the data reception timing creating unit 22 inputs, to each of the CK terminals at FFs for the DQ signal [0], a clock signal each having a different phase in stages.

The counter in the data reception timing creating unit 22 counts the number of clocks of the clock signal that is output by the DLL circuit and notifies the decoder of the counted value. The decoder in the data reception timing creating unit 22 sends an enable signal to each of the FFs in the data reception FF unit 23 in accordance with the value received as a notification from the counter.

Specifically, the data reception timing creating unit 22 determines what number of the data is indicated by the DQ signal [0] that is received by the data sending unit 14 and then selects, in accordance with the determined number, a FF to be operated from among FFs in the data reception FF unit 23. Specifically, by using FFs arranged at different levels, the data reception timing creating unit 22 latches the DQ signal [0] for each piece of data subjected to the burst transmission performed by the data sending unit 14.

Furthermore, each of the FFs in the data reception FF unit 23 receives the DQ signal [0] from the data sending unit 14. Then, each of the FFs latches the DQ signal [0] when the clock signal that is input from the data reception timing creating unit 22 becomes “High”. Specifically, each of the FFs in the data reception FF unit 23 latches the DQ signal [0] at different timings.

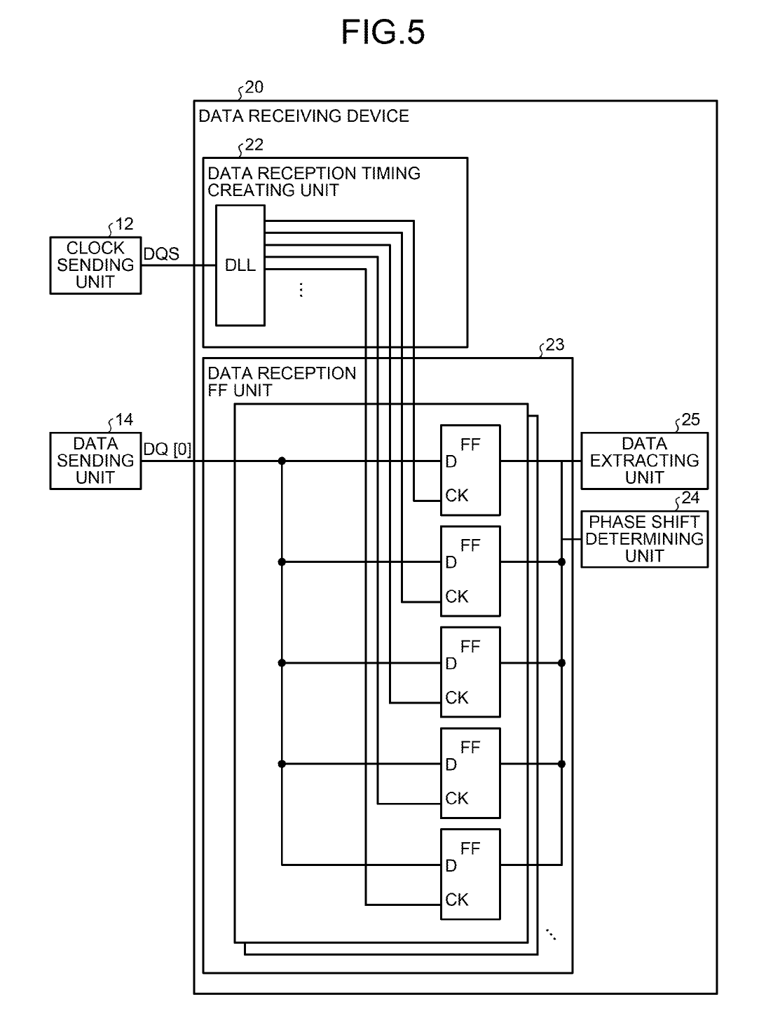

FIG. 5 is a schematic diagram illustrating an example of a data reception FF unit. In the example illustrated in FIG. 5, the data reception FF unit 23 includes, for each DQ signal, D-type FFs that are used to latch the DQ signal [0] at timings. In this example, it is assumed that the data reception FF unit 23 includes FFs with the number of FFs that can latch one cycle of the DQ signal [0].

In other words, the data reception timing creating unit 22 creates, by the DLL circuit, clock signals that is delayed by the cycle longer than one cycle of the DQ signal and supplies different clock signals to each of the FF in the data reception FF unit 23. Consequently, the data reception FF unit 23 samples the DQ signal [0] in the cycle longer than that of the DQ signal.

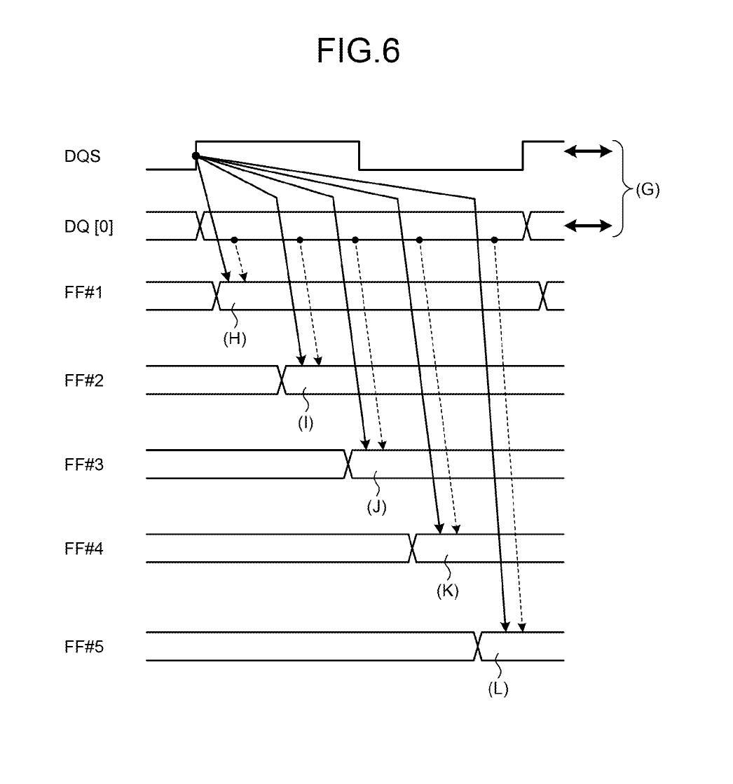

FIG. 6 is a schematic diagram illustrating the timing at which the data reception FF unit according to the first embodiment latches data. FIG. 6 illustrates the waveform of the DQS signal, the waveform of the DQ signal [0], and the timing at which each of the FFs in the data reception FF unit 23 latches a value. Furthermore, as illustrated by (G) in FIG. 6, it is assumed that a delay in each of the DQS signal and the DQ signal [0] occurs between the data sending device 10 and the data receiving device 20. Furthermore, FIG. 6 illustrates an example of the data reception FF unit 23 that includes five FFs #1 to #5.

In the example illustrated in FIG. 6, the DQS signal received by the data receiving device 20 is a single signal. However, the data reception timing creating unit 22 creates, from the DQS signal by using the DLL circuit, clock signals whose phases differ in stages. Then, each of the FFs #1 to #5 in the data reception FF unit 23 latches the DQ signal [0] by using different clock signals.

Specifically, in the example illustrated in FIG. 6, the FF#1 latches the DQ signal [0] at the timing indicated by (H) in FIG. 6; the FF#2 latches the DQ signal [0] at the timing indicated by (I) in FIG. 6; the FF#3 latches the DQ signal [0] at the timing indicated by (J) in FIG. 6; the FF#4 latches the DQ signal [0] at the timing indicated by (K) in FIG. 6; and the FF#5 latches the DQ signal [0] at the timing indicated by (L) in FIG. 6. Specifically, each of the FFs #1 to #5 latches the DQ signal [0] at different timings in stages.

A description will be given here by referring back to FIG. 4. The phase shift determination circuit 24a acquires the value latched by each of the FFs in the data reception FF unit 23. Furthermore, the phase shift determination circuit 24a receives, via a switching circuit 29, the DQR signals [0] to [n] that are sent from the reliable data sending unit 16. Then, the phase shift determination circuit 24a compares the value latched by each of the FFs in the data reception FF unit 23 with the value of the DQR signal [0] and then notifies the selector 24b of the comparison result.

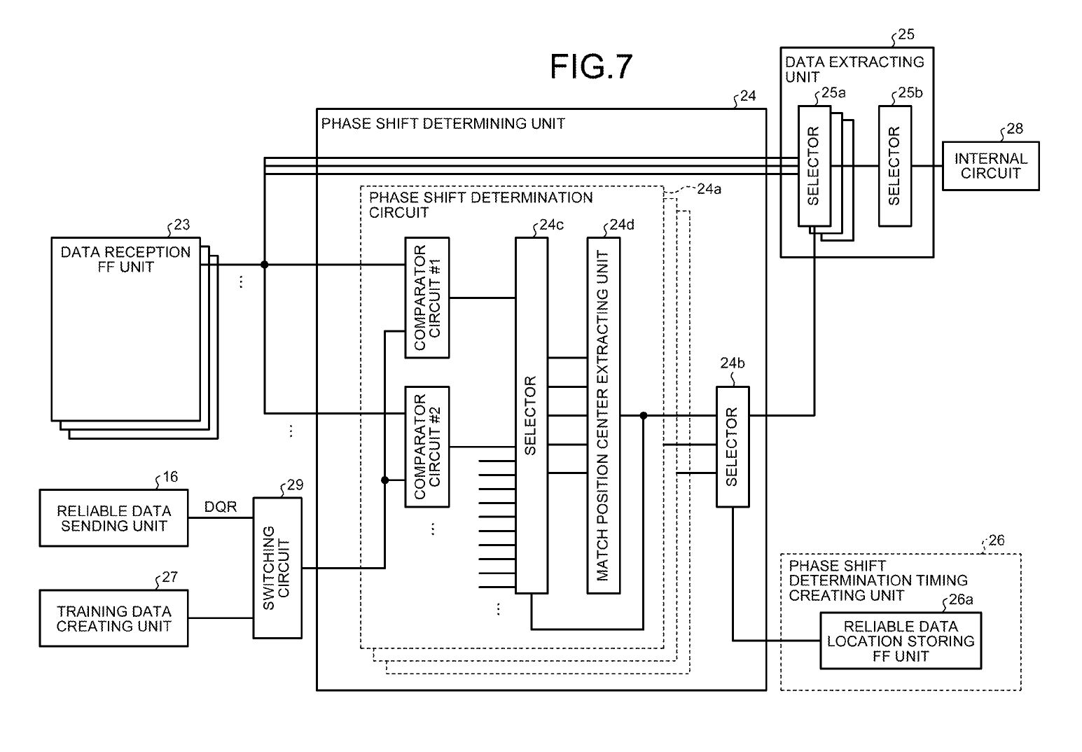

In the following, a description will be given of an example of the phase shift determination circuit 24a. FIG. 7 is a schematic diagram illustrating an example of a phase shift determining unit according to the first embodiment. In the example illustrated in FIG. 7, the phase shift determining unit 24 includes the phase shift determination circuit 24a and the selector 24b. Furthermore, the phase shift determination circuit 24a includes comparator circuits, a selector 24c, and a match position center extracting unit 24d.

Although not illustrated in FIG. 7, it is assumed that the phase shift determination circuit 24a includes ten comparator circuits #1 to #10. Furthermore, it is assumed that the phase shift determining unit 24 includes the same number of phase shift determination circuits 24a corresponding to the number of times the data sending device 10 performs the burst transmission and it is assumed that the determination is performed on the shift of the phase of the data that has been subjected to the burst transmission at different timings.

Each of the comparator circuits #1 to #10 determines whether the DQR signal [0] matches data latched from the DQ signal [0] by the data reception FF unit 23 at different timings and then outputs the determination result to the selector 24c. The selector 24c receives the determination result obtained by each of the comparator circuits #1 to #10 and then selects, as the comparison result that is used to determine the phase shift, some of the received determination results. Each of the comparator circuits #1 to #10 determines, in accordance with the operation clock of the data receiving device 20, whether the data latched by the data reception FF unit 23 matches the DQR signal [0].

Furthermore, when the determination result indicating that the data latched from the DQ signal [0] does not match the DQR signal [0] is contained in the selected comparison result, the selector 24c selects a new determination result such that the determination result indicating that the data does not match the DQR signal [0] is not included in the selected comparison result. Specifically, when the selector 24c receives, from the match position center extracting unit 24d, a notification indicating that a new determination result is selected, the selector 24c selects a new determination result.

For example, when the selector 24c selects the comparator circuits #1 to #5 and receives a notification indicating that a determination result obtained from two previous stages is to be selected, the selector 24c newly selects a determination result that is obtained by each of the comparator circuits #9, #10, and #1 to #3. Furthermore, when the selector 24c selects the comparator circuits #1 to #5 and receives a notification indicating that a determination result obtained from one subsequent stage is to be newly selected, the selector 24c newly selects a determination result that is obtained by each of the comparator circuits #2 to #6. Furthermore, the selector 24c sends the selected determination result to the match position center extracting unit 24d.

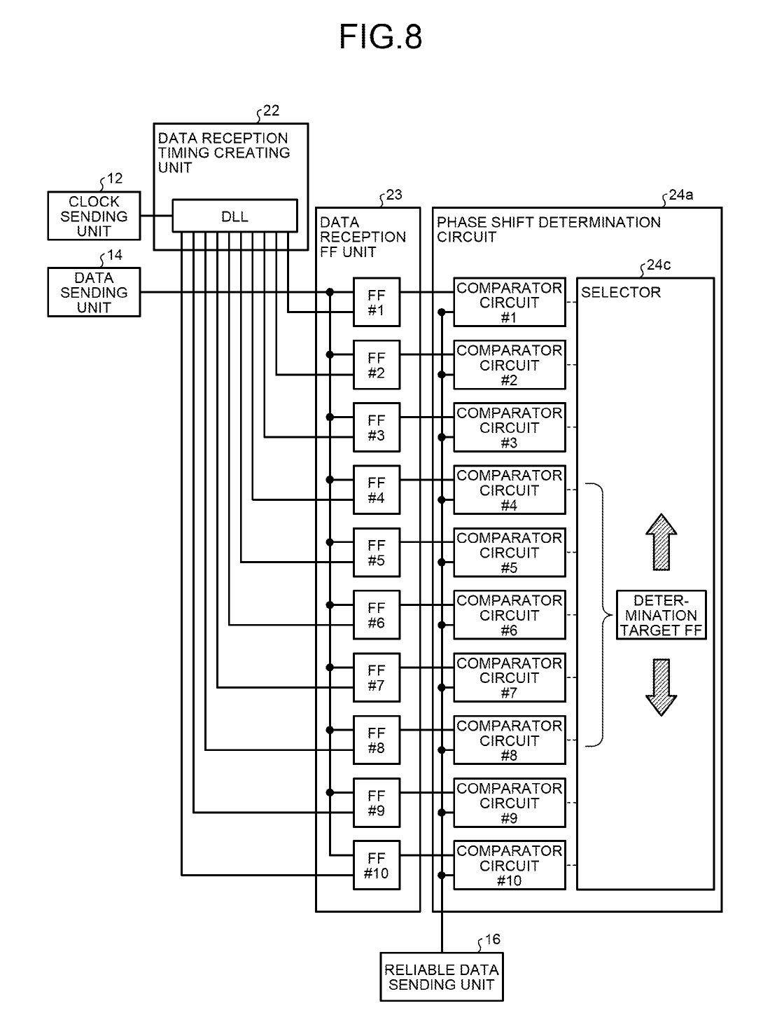

FIG. 8 is a schematic diagram illustrating an example of a phase shift determination circuit according to the first embodiment. In the example illustrated in FIG. 8, the data reception FF unit 23 includes 10 FFs#1 to #10 each of which latches the DQ signal [0]. Furthermore, the phase shift determination circuit 24a includes 10 comparator circuits #1 to #10 each of which compares the value that has been latched by each of the FFs #1 to #10 with the DQR signal [0] that has been sent by the reliable data sending unit 16.

Each of the comparator circuits #1 to #10 is, for example, an exclusive OR (EOR) gate and determines whether the value latched by each of the FFs #1 to #10 matches the DQR signal [0] by calculating exclusive disjunction between the values latched by the FFs #1 to #10 and the DQR signal [0]. Then, each of the comparator circuits #1 to #10 sends the determination result to the selector 24c.

Furthermore, when the selector 24c selects the comparison results obtained by the comparator circuits #4 to #8 and when the comparator circuit #4 outputs a comparison result indicating that the value latched by the FF #4 does not match the DQR signal [0], the selector 24c newly selects the comparison results obtained by each of the comparator circuits #5 to #9. Furthermore, when the selector 24c selects the comparison results obtained by the comparator circuits #4 to #8 and when each of the comparator circuits #7 and #8 outputs a comparison result indicating that the value latched by each of the FFs #7 and #8 does not match the DQR signal [0], the selector 24c newly selects the comparison results obtained by the comparator circuits #2 to #6. Then, the selector 24c sends the selected comparison results to the match position center extracting unit 24d.

The match position center extracting unit 24d extracts, from among the determination results selected by the selector 24c, a FF related to the comparator circuit that has output the main determination result. The main determination result mentioned here is, from among the determination results selected by the selector 24c, the determination result of the clock signal whose phase is located in the middle portion and that is used when data is latched from the DQ signal [0]. For example, when the selector 24c selects the comparator circuits #1 to #5, the match position center extracting unit 24d extracts the FF #3 related to the comparator circuit #3. Then, the match position center extracting unit 24d notifies the selector 25a of the extracted FF.

Furthermore, if the comparison result contains information indicating that the latched DQ signal [0] does not match the DQR signal [0], the match position center extracting unit 24d performs the following process. Namely, when one of the comparator circuits #1 to #10 arranged downstream outputs the comparison result indicating that data does not match, the match position center extracting unit 24d sends a notification to the selector 24c indicating that the comparison result obtained by the comparator circuit arranged upstream is output. Furthermore, when one of the comparator circuits #1 to #10 arranged upstream outputs the comparison result indicating that data does not match, the match position center extracting unit 24d sends a notification to the selector 24c indicating that the comparison result obtained by the comparator circuit arranged downstream is output. Furthermore, the match position center extracting unit 24d counts the number of comparison results indicating that data does not match and then notifies the selector 24c of the number of obtained counts.

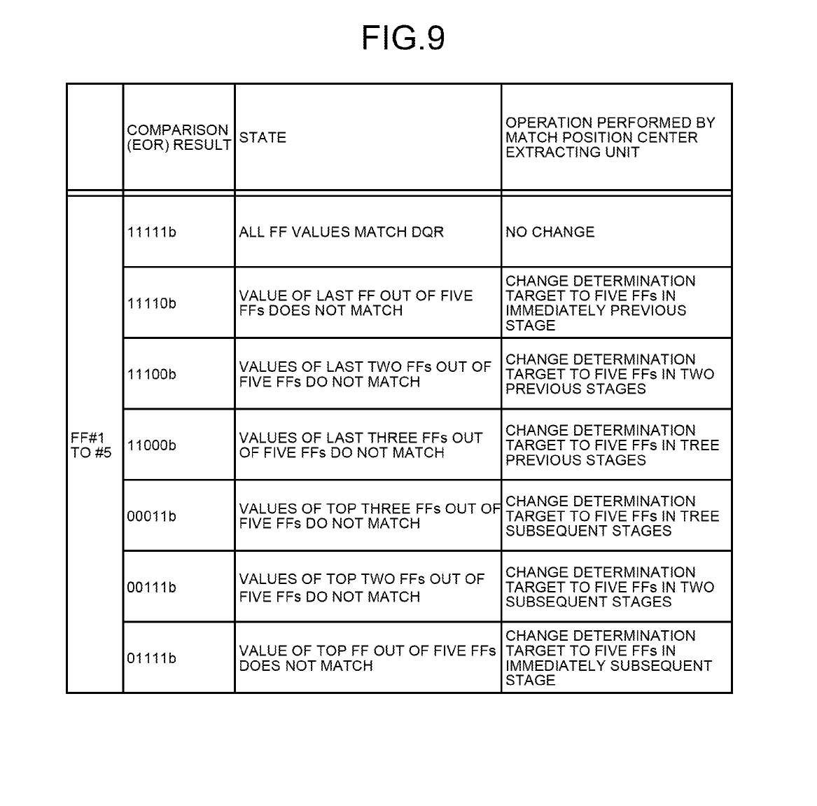

In the following, an example of a process in which the match position center extracting unit 24d newly selects a comparison result will be described with reference to FIG. 9. FIG. 9 is a schematic diagram illustrating an example of a process performed by a match position center extracting unit according to the first embodiment. FIG. 9 illustrates an example in which the selector 24c acquires, as the comparison result, exclusive disjunction between the DQ signal [0] latched by each of the FFs #1 to #5 and the DQR signal [0]. It is assumed that each of the FFs #1 to #5 latches the DQ signal [0] in accordance with the clock signal whose phase is gradually delayed in the order of FF #1 toward FF#5.

For example, if the selected comparison result is “11111b”, i.e., if the DQ signal [0] latched by each of the FFs #1 to #5 matches the DQR signal [0], the match position center extracting unit 24d continues performing the process without changing the selected comparison result. Furthermore, if the selected comparison result is “11110b”, the match position center extracting unit 24d determines that the DQ signal [0] latched by the FF#5 does not match the DQR signal [0].

Then, the match position center extracting unit 24d sends a notification to the selector 24c indicating that the selection target is set to the comparison result obtained from the immediately previous stage. Specifically, the match position center extracting unit 24d indicates that the timing at which data is to be read is shifted from the timing that is indicated by the clock signal to which an appropriate delay amount is added. Consequently, because the selector 24c changes the selection target to the comparison result obtained from the immediately previous stage, data can be read by using a clock signal with an appropriate phase.

Furthermore, if the selected comparison result is “11100b”, the match position center extracting unit 24d determines that the DQ signal [0] latched by each of the FF #5 and the FF#4 does not match the DQR signal [0]. Then, the match position center extracting unit 24d sends a notification to the selector 24c indicating that the selection target is set to the comparison result obtained from the two previous stages. Furthermore, if the selected comparison result is “11000b”, the match position center extracting unit 24d determines that the DQ signal [0] latched by each of the FFs #5 to #3 does not match the DQR signal [0]. Then, the match position center extracting unit 24d sends a notification to the selector 24c indicating that the selection target is set to the comparison result obtained from the three previous stages.

Furthermore, if the selected comparison result is “00011b”, the match position center extracting unit 24d determines that the DQ signal [0] latched by each of the FFs #1 to #3 does not match the DQR signal [0]. Then, the match position center extracting unit 24d sends a notification to the selector 24c indicating that the selection target is set to the comparison result obtained from the three subsequent stages. Furthermore, if the selected comparison result is “00111b”, the match position center extracting unit 24d determines that the DQ signal [0] latched by each of the selected FF #1 and the FF #2 does not match the DQR signal [0]. Then, the match position center extracting unit 24d sends a notification to the selector 24c indicating that the selection target is set to the comparison result obtained from the two subsequent stages. Furthermore, if the selected comparison result is “01111b”, the match position center extracting unit 24d determines that the DQ signal [0] latched by the FF#1 does not match the DQR signal [0]. Then, the match position center extracting unit 24d sends a notification to the selector 24c indicating that the selection target is set to the comparison result obtained from the immediately subsequent stage.

A description will be given here by referring back to FIG. 7. The selector 24b selects an output from the phase shift determination circuit 24a that receives the data indicated by the DQR signal [0]. Specifically, the selector 24b selects an output from the phase shift determination circuit 24a that compares the DQ signal [0] that is created from originally the same data with the DQR signal [0]. In other words, the selector 24b refers to the reliable data location storing FF unit 26a in the phase shift determination timing creating unit 26 and then selects the phase shift determination circuit 24a obtained from the result of comparing the DQR signal [0] with the DQ signal [0] that is to be compared.

The reliable data location storing FF unit 26a in the phase shift determination timing creating unit 26 allows the reception control unit 21 to set information that indicates that the DQ signal [0] that is to be compared with the DQR signal [0] is what number of the DQ signal [0]. For example, when the data sending device 10 creates DQR signals [0] to [n] from the DQ signals [0] to [n] that are to be sent for the fourth time, the reception control unit 21 stores “4” in the reliable data location storing FF unit 26a. In such a case, the selector 24b selects a determination result of the level in which the data sending device 10 compares the DQ signals [0] to [n], which is sent at N^{th} time (N is a multiple of 4), with the DQR signals [0] to [n], respectively.

The selector 25a in the data extracting unit 25 acquires, from among the FFs #1 to #10 in the data reception FF unit 23, data that is latched by the FF notified by the selector 24b. Similarly to the data reception FF unit 23, the data extracting unit 25 includes the multiple number of selectors 25a corresponding to the number of levels.

Then, the selector 25a at each level acquires, from each of the FFs #1 to #10 in the data reception FF unit 23 at each level, the data that is latched by the FF notified by the selector 24b. For example, if the data reception FF unit 23 includes the FFs #1 to #10 at four levels and receives a notification from the selector 24b indicating the FF #3, the data extracting unit 25 acquires data that has been latched by the FF #3 included in the data reception FF unit 23 in each of the levels.

A description will be given here by referring back to FIG. 4. The selector 25b determines, on the basis of an output from the decoder in the data reception timing creating unit 22, which level of the FFs #1 to #10 have latched the last received data. From among the data, i.e., DQ [0, 1], DQ [0, 2]. . . , and DQ [0, n], acquired by the selector 25a at each level, the selector 25b acquires the data at the determined level and sends the acquired data to the internal circuit 28. Specifically, from among the data received by the data reception FF unit 23 at each level, the selector 25b acquires the data related to the last received DQ signal [0] and then sends the acquired data to the internal circuit 28.

The transmission system 1 sends and receives training data when the system is booted up, whereby the transmission system 1 adjusts a delay amount that is added to the DQS signal for the first time. For example, when the transmission system 1 sends the training data, the transmission system 1 performs the following process. Namely, the data sending unit 14 continuously sends the DQ signals [0] to [n] indicating the training data to the data reception FF unit 23. In contrast, the data receiving device 20 inputs, by using the switching circuit 29, the training data created by the training data creating unit 27 to the phase shift determination circuit 24a.

In such a case, the phase shift determination circuit 24a compares the training data acquired by the data reception FF unit 23 using clock signals with the data created by the training data creating unit 27 in order to determine whether the training data matches the data. If the phase shift determination circuit 24a determines that both data match, the reception control unit 21 ends the process that sends the training data from the data sending device 10.

As described above, the transmission system 1 receives, by using clock signals whose phases shift, the DQ signals [0] to [n] that indicate the training data and then compares the received data with the training data created by the training data creating unit 27. Consequently, when the transmission system 1 is initialized or the like, it is possible to reduce the process for detecting an appropriate delay amount of the DQS signal, and thus it is possible to prevent the transmission efficiency from being degraded.

Furthermore, because the transmission system 1 receives the training data by using clock signals, the transmission system 1 can more promptly initialize the system compared with a conventional transmission system. Specifically, the conventional transmission system can evaluate only one delay amount when a training data is transmitted once.

In contrast, the transmission system 1 receives training data by using clock signals. Consequently, for example, when the transmission system 1 receives the training data by using 10 clock signals whose phases differ, it is possible to reduce, compared with the conventional transmission system, the number of times the training data is sent and received to 1/10. Consequently, the transmission system 1 can promptly perform the initialization.

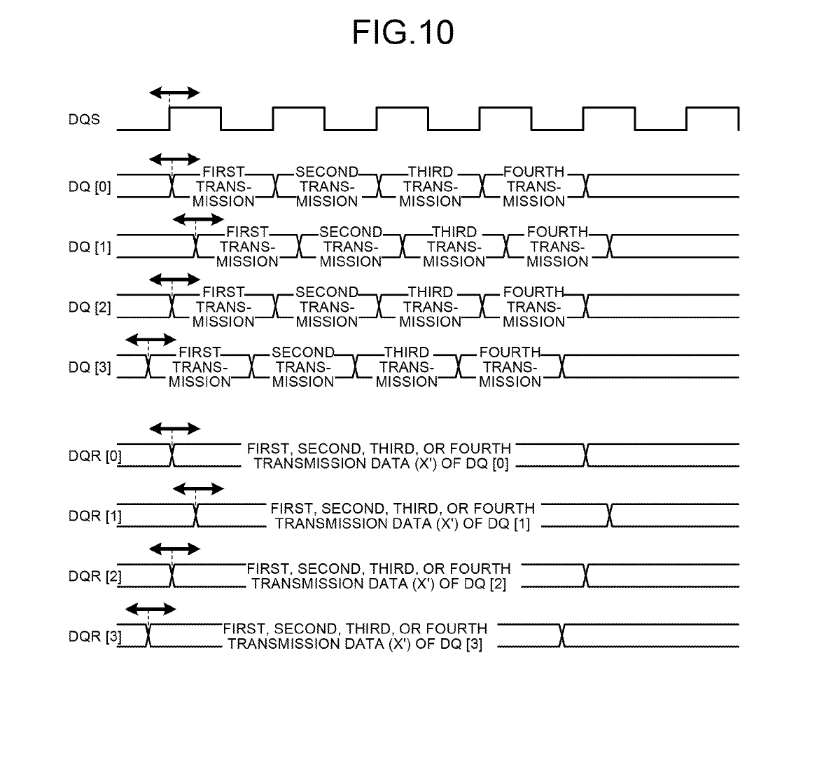

In the following, the relationship between the signals that are sent and received by the transmission system 1 will be described with reference to FIG. 10. FIG. 10 is a schematic diagram illustrating the relationship among signals sent by a transmission system according to the first embodiment. The example illustrated in FIG. 10 indicates the waveform of the DQS signal, the contents of the data sent by the DQ signals [0] to [3], and the contents of the data indicated by the DQR signals [0] to [3]. Furthermore, as illustrated in FIG. 10, a delay occurs in each of the signals.

As illustrated in FIG. 10, the data sending device 10 sends, for four times, each of the DQ signals [0] to [3] at the same cycle as that of the DQS signal. At this point, for each of the DQ signals [0] to [3], because the ratio of the cycle to a delay is small, there may be a case in which data is not accurately read. In contrast, because each of the DQR signals [0] to [3] has the cycle four times as much as that of the DQ signals [0] to [3], even when a delay occurs, data can be appropriately received. Specifically, the data receiving device 20 can latch reliable data from the DQR signals [0] to [3].

At this point, because each of the DQR signals [0] to [3] has the cycle four times as much as that of the DQ signals [0] to [3], the amount of data available for transmission becomes ¼. However, by comparing the DQ signals [0] to [3] with the DQR signals [0] to [3], respectively in order to determine whether the signals match, the data receiving device 20 can accurately adjust the phase.

Specifically, the data receiving device 20 receives the DQ signals [0] to [3] at the multiple timings and uses reliable data that has been sent by using a long cycle, whereby the data receiving device 20 can appropriately and dynamically determine the timing at which the DQ signals [0] to [3] is to be received. Consequently, because the transmission system can prevent the occurrence of an error without sending the training data, the transmission system can prevent a decrease in the transmission efficiency without reducing the reliability of the data.

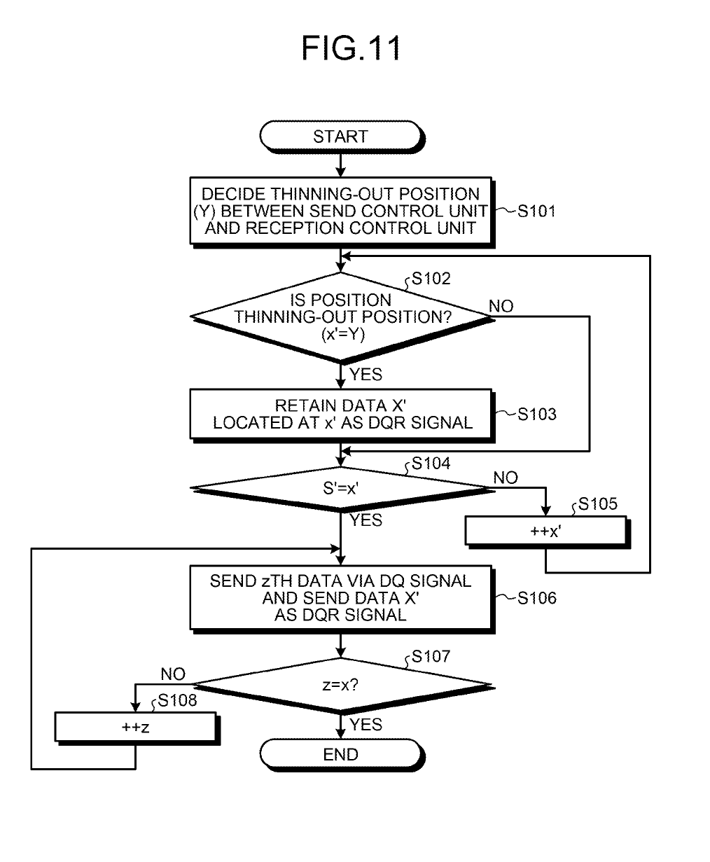

In the following, an example of the flow of a process performed by the transmission system 1 according to the first embodiment will be described. First, an example of the flow of the process performed by the data sending device 10 will be described with reference to FIG. 11. FIG. 11 is a flowchart illustrating the flow of a process performed by a data sending device according to the first embodiment.

In the example illustrated in FIG. 11, the data sending device 10 decides a thinning-out position (Y) between the send control unit 11 and the reception control unit 21 (Step S101). Then, the data sending device 10 determines whether the number of data (x′) that has been sent by the data sending device 10 via a DQ matches the thinning-out position (Y) (Step S102). If the data sending device 10 determines that (x′) matches (Y) (Yes at Step S102), the data sending device 10 retains the data (X′) whose position is (x′) as a DQR signal (Step S103). In contrast, the data sending device 10 determines that the number of data (x′) that has been sent via the DQ does not match the thinning-out position (Y), the data sending device 10 cancels the process performed at Step 5103.

Furthermore, the data sending device 10 determines whether the number of data (x′) matches the total number of the send data (S′) (Step S104). When it is determined that (x′) does not match (S′) (No at Step S104), the data sending device 10 adds 1 to (x′) (Step S105) and again determines whether (x′) matches (Y) (Step S102).

Furthermore, when the data sending device 10 determines that (x′) matches (S′) (Yes at Step S104), the data sending device 10 sends the (z)^{th} data by using the DQ signal and sends, as the DQR signal, the data (X′) (Step S106). Then, the data sending device 10 determines whether (z) matches (x) (Step S107). If the data sending device 10 determines that they both match (Yes at Step S107), the data sending device 10 ends the process. In contrast, the data sending device 10 determines that (z) does not match (x) (No at Step S107), the data sending device 10 adds 1 to (z) (Step S108). Then, the data sending device 10 again sends (z)^{th} data by using the DQ signal and sends, as the DQR signal, the data (X′) (Step S106).

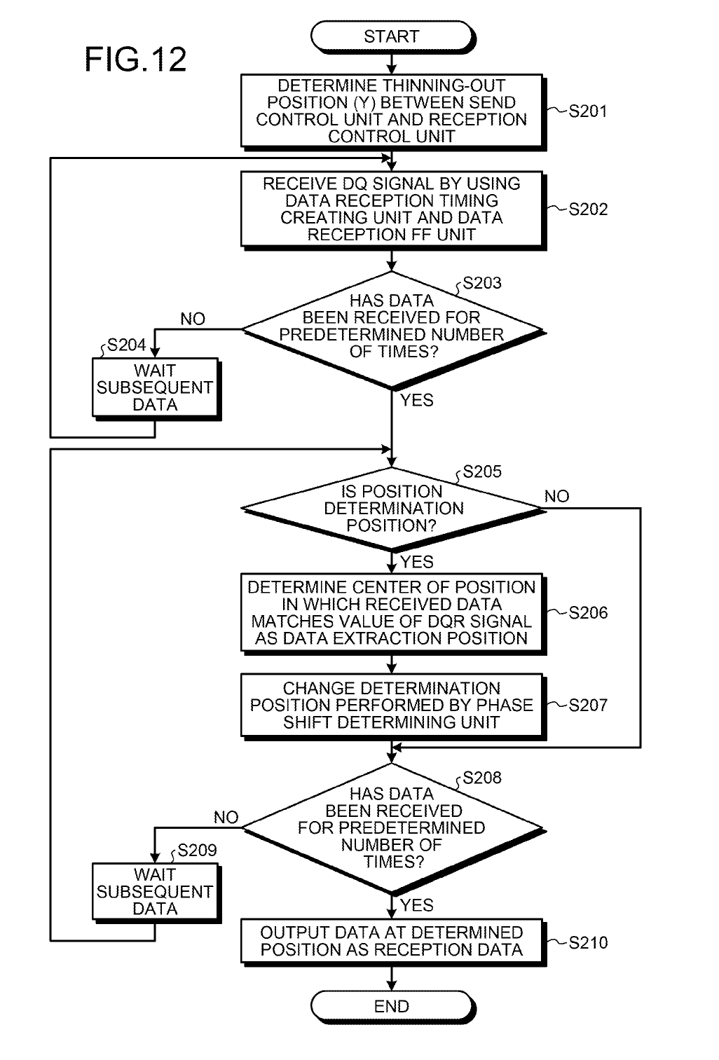

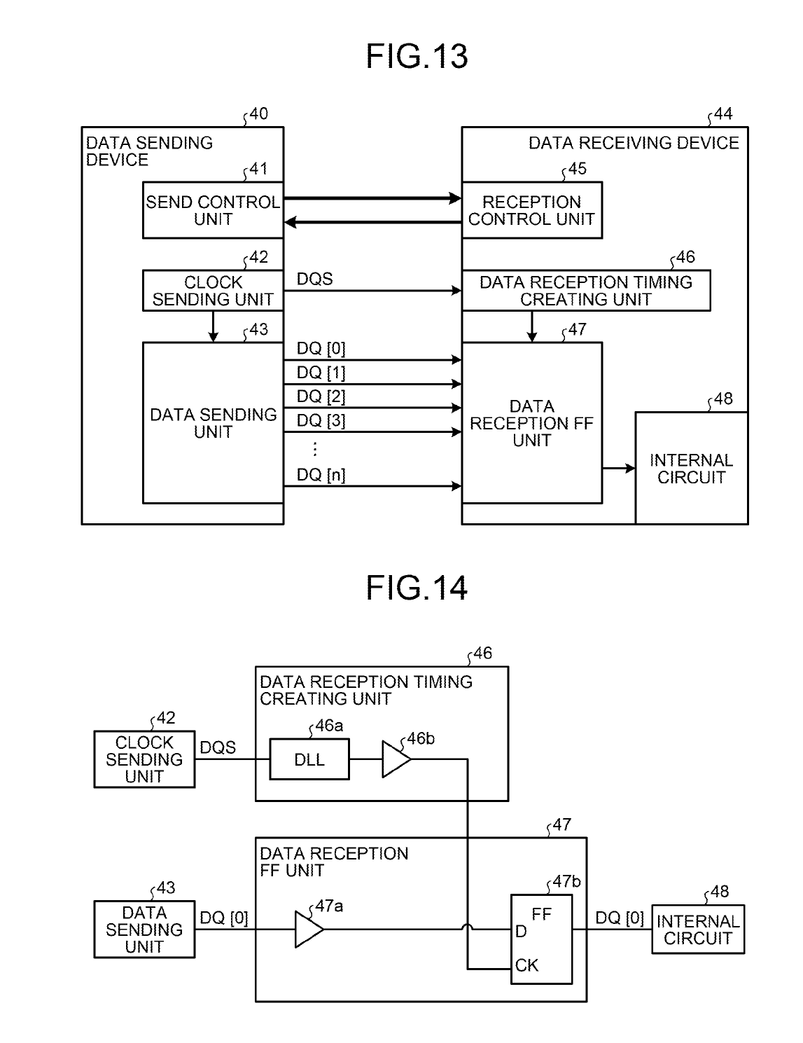

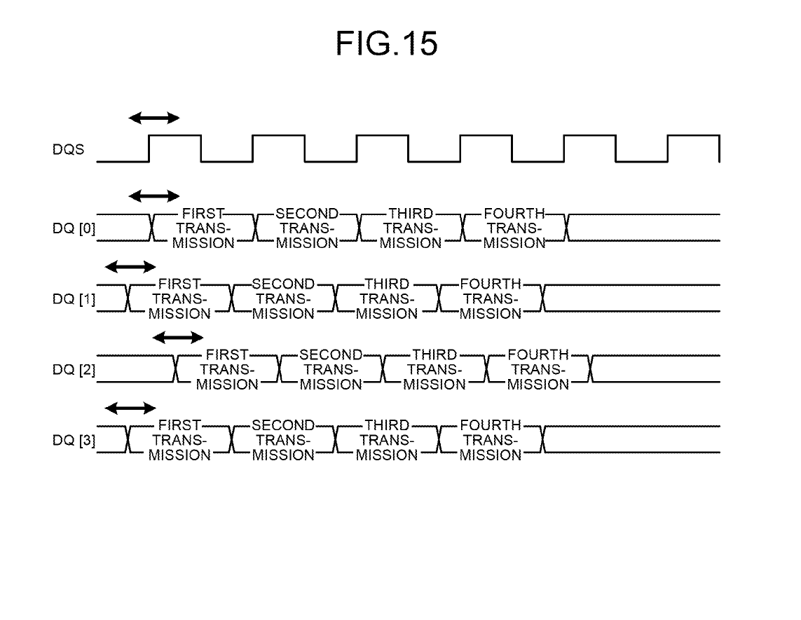

In the following, an example of the flow of a process performed by the data receiving device 20 will be described with reference to FIG. 12. FIG. 12 is a flowchart illustrating the flow of a process performed by a data receiving device according to the first embodiment. In the example illustrated in FIG. 12, similarly to FIG. 11, the data receiving device 20 performs a process for determining the thinning-out position (Y) between the send control unit 11 and the reception control unit 21 (Step S201).

Then, by using clock signals that are created by the data reception timing creating unit 22 and whose phases differ, the data receiving device 20 receives the data containing the DQ signal [0] at the data reception FF unit 23 (Step S202). Then, the data receiving device 20 determines whether the data of the DQ signal [0] is received for a predetermined number of times (Step S203). If it is determined that the data is not received for a predetermined number of times (No at Step S203), the data receiving device 20 waits the subsequent data to be received (Step S204). Thereafter, the data receiving device 20 again performs the process at Step 5202.

In contrast, if the data receiving device 20 determines that the data of the DQ signal [0] is received for a predetermined number of times (Yes at Step S203), the data receiving device 20 determines whether the received data is the data that is to be subjected to the phase shift determination (Step S205).

If the data receiving device 20 determines that the received data is to be subjected to the phase shift determination (Yes at Step S205), the data receiving device 20 determines that, from among the received data, the center of the position that matches the value of the DQR signal as the data extraction position (Step S206). Furthermore, the data receiving device 20 changes the determination position performed by the phase shift determining unit 24, i.e., the position of the determination result selected by the selector 24b (Step S207).

Then, if the received data is the data that is not subjected to the phase shift determination (No at Step S205), the data receiving device 20 skips the processes performed at Steps S206 and S207. Furthermore, the data receiving device 20 determines whether the data has been received for the predetermined number of times (Step S208). If the data receiving device 20 determines that the data has been received for the predetermined number of times (Yes at Step S208), the data receiving device 20 outputs, as reception data, the data that is determined to be located at the data extraction position (Step S210) and then ends the process.

Furthermore, if the data receiving device 20 determines that the data has not been received for the predetermined number of times (No at Step S208), the data receiving device 20 waits the subsequent data (Step S209) and performs the process at Step S205.

As described above, the transmission system 1 includes the data sending device 10 and the data receiving device 20. The data sending device 10 sends, to the data receiving device 20, DQ signals and some of the DQ signals as DQR signals whose speed is lower than that of the DQ signal. Furthermore, the data receiving device 20 creates clock signals having different phases and then receives DQ signals by using the created clock signals. Then, in accordance with the determination as to whether a DQ signal that is from among the received DQ signals and that is associated with the DQR signal matches the DQR signal, the data receiving device 20 changes the timing at which the DQ signal is received.

Consequently, because the transmission system 1 can adjust a delay amount to be added to a DQS signal, without sending the training pattern, while sending and receiving normal information, the transmission system 1 can adjust a delay in a clock signal by taking into consideration a decrease in the transmission efficiency. Furthermore, because the transmission system 1 outputs some of the DQ signals as signals whose speed is lower than that of the DQ signals, i.e., as a DQR signal that has the cycle longer than that of the DQ signals, it is possible to improve the reliability of a signal that is used to check the phase. Consequently, because the transmission system 1 adjusts, by using reliable data, a delay amount that is to be added to a DQS signal, it is possible to improve the reliability of the adjusting process.

Specifically, because the transmission system 1 can appropriately adjust a delay amount of a DQS signal by using a reliable DQR signal even when normal data transmission is being performed, the transmission system 1 can reduce the number of times of readjustments. Consequently, the transmission system 1 can prevent a decrease in the transmission efficiency of data.

Furthermore, the transmission system 1 adjusts a delay amount of a DQS signal by using a reliable DQR signal. Consequently, the transmission system 1 does not perform an erroneous adjustment even if the phase of a DQ signal or a DQS signal changes over the phases or even if a value may be garbled due to noise. Consequently, the transmission system 1 can improve the reliability of data.

Furthermore, because the data receiving device 20 outputs, as received data, data that has the same value as that indicated by a DQR signal, the reliability of the data can be further improved.

Furthermore, the data receiving device 20 selects a predetermined number of data from data that has been received by using clock signals having different phases and then detects, from the selected data, data that is different from the DQR signal. Then, when the data receiving device 20 detects the data that is different from the DQR signal, the data receiving device 20 changes data that is to be selected such that a predetermined number of data is selected from among data other than the detected data. Consequently, the data receiving device 20 can set the timing at which the data is read within the range in which the data can be accurately read. Consequently, the data receiving device 20 can further improve the reliability of the data.

Furthermore, when the data receiving device 20 detects data that is different from a DQR signal, the data receiving device 20 counts the number of detected data. Then, the data receiving device 20 newly selects data that has been latched by clock signals whose phase differs by the counted number in the direction in which data that is different from the DQR signal is included. Consequently, the data receiving device 20 can continuously set the timing at which the data is read within the range in which the data can be accurately read. Consequently, the data receiving device 20 can further improve the reliability of the data.

Furthermore, the data receiving device 20 creates clock signals having different phases from a DQS signal and receives, by using the created clock signals, DQ signals. Consequently, the transmission system 1 can reduce the number of times the training data is received when initialization is performed. For example, when the data receiving device 20 receives the training data by using 10 clock signals having different phases, the transmission system 1 can verify 10 patterns at a single reception. Consequently, when compared with the conventional transmission system, the transmission system 1 can substantially reduce the transmission time of the training data.

### [b] Second Embodiment

In the above explanation, a description has been given of the embodiment according to the present invention; however, the embodiment is not limited thereto and can be implemented with various kinds of embodiments other than the embodiment described above. Therefore, another embodiment included in the present invention will be described as a second embodiment below.

(1) The Number of Signals

The transmission system 1 described above sends and receives between DQ signals and DQR signals. However, in the transmission system 1, an arbitrary number of signals may also be used for each signal line. Specifically, the transmission system 1 may also send and receive between an arbitrary number of DQ signals and DQR signals regardless of the specific number of signals described in the first embodiment.

(2) Timing at Which Data is Thinned Out

The transmission system 1 described above thins out data every time the data sending unit 14 sends four pieces of data and then sends a DQR signal that has the cycle four times as long as the cycle of a DQ signal; however, the embodiment is not limited thereto. Specifically, the transmission system 1 can set an arbitrary value for the process for thinning out data performed by the thinning-out processing unit 15.

Furthermore, with the transmission system 1 described above, the send control unit 11 and the reception control unit 21 thin out data or create a DQR signal in accordance with the values stored in the thinning-out position register 15a and the reliable data location storing FF unit 26a; however, the embodiment is not limited thereto. For example, when the data sending device 10 and the data receiving device 20 are designed, data may also be thinned out or a DQR signal may also be sent every time a predetermined number of data is sent.

According to an aspect of an embodiment of the present invention, an advantage is provided in that it is possible to adjust a delay in a clock signal by taking into consideration a decrease in the transmission efficiency.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission system comprising:
a sending device that includes
a first sending unit that sends data at a first speed, and
a second sending unit that sends, at a second speed that is lower than the first speed, some of the data sent from the first sending unit; and
a receiving device that includes
a clock creating unit that creates a plurality of clocks having different phases,
a plurality of receiving units which receive, by using the plurality of clocks created by the clock creating unit, respectively, the data that has been sent from the first sending unit, and
a changing unit that changes, in accordance with determination as to whether the content of the received data sent from the second sending unit matches a corresponding portion of the data received by the plurality of receiving units, the timing at which the data that has been sent from the first sending unit is received.

2. The transmission system according to claim 1, wherein
the receiving device further includes a selecting unit that selects a predetermined number of data from among the data received by the plurality of receiving units by using a plurality of clocks whose phase continue,
the receiving device further includes a detecting unit that detects, from among the data selected by the selecting unit, data that does not match the content of the received data sent from the second sending unit, and
when the detecting unit detects data that does not match the content of the received data sent from the second sending unit, the changing unit changes data that is to be selected by the selecting unit such that the selecting unit selects a predetermined number of data other than the data that does not match the content of the received data sent from the second sending unit.

3. The transmission system according to claim 1, wherein, when the detecting unit detects data that does not match the content of the received data sent from the second sending unit, the selecting unit counts the number of data that does not match the content of the received data sent from the second sending unit and shifts, by the counted number, data that is to be selected by the selecting unit.

4. The transmission system according to claim 3, wherein the receiving device further includes an output unit that outputs data, from among the data received by the plurality of receiving units, that is detected by the detecting unit and that matches the content of the received data sent from the second sending unit.

5. A sending device comprising:
a first sending unit that sends data at a first speed; and
a second sending unit that sends, at a second speed that is lower than the first speed, some of the data sent from the first sending unit.

6. A receiving device comprising:
a clock creating unit that creates a plurality of clocks having different phases;
a plurality of first receiving units which receive, by using the plurality of clocks created by the clock creating unit, respectively, data sent from a sending device, which is the send source of the data, at a first speed;
a second receiving unit that receives data that has been sent at a second speed that is lower than the first speed and that is some of the data that has been sent at the first speed by the sending device; and
a changing unit that changes, in accordance with determination as to whether the data received by the second receiving unit matches a corresponding portion of the data received by the plurality of first receiving units, the timing at which the data sent from the plurality of first receiving units is received.

7. A transmission method executed by a transmission system that includes a sending device that sends data at a first speed and a receiving device that receives, by using a plurality of clocks having different phases, the data sent from the sending device at a first speed, the transmission method comprising:
sending, performed by the sending device, at a second speed that is lower than the first speed, some of the data sent at the first speed; and
changing, performed by the receiving device, in accordance with determination as to whether the content of the received data sent at the second speed matches a corresponding portion of the data that is received by using the plurality of clocks, the timing at which the data sent at the first speed is received.
